(19) United States
(12) Patent Application Publication
(10) Pub. No.: US 2017/0064944 A1
(43) Pub. Date: Mar. 9, 2017

(54) EMULSIFIABLE OR SELF-EMULSIFYING CYANAMIDE-CONTAINING COMPOSITION

(71) Applicant: ALZCHEM AG, Trostberg (DE)

(72) Inventor: Thomas GÜTHNER, Trostberg (DE)

(73) Assignee: ALZCHEM AG, Trostberg (DE)

(21) Appl. No.: 15/122,451

(22) PCT Filed: Feb. 26, 2015
(86) PCT No.: PCT/EP2015/054051

§ 371 Date: Aug. 30, 2016

(30) Foreign Application Priority Data
Mar. 1, 2014 (DE) 10 2014 003 082.2

(51) Int. Cl. A01N 25/04; A01N 59/24

(52) U.S. Cl. CPC A01N 25/04; A01N 59/24

(57) ABSTRACT

The present invention relates to an emulsifiable or self-emulsifying liquid composition for plant growth control which contains cyanamide.

The present invention relates to an emulsifiable or self-emulsifying liquid composition for regulating plant growth which contains cyanamide.

Cyanamide was first synthetically produced in 1838 by A. Bineau by reacting ammonia and chlorocyan (Ann. Chim. Paris 67 (1838) 225-272). In technical quantities, cyanamide is nowadays obtained from calcium cyanamide. A sophisticated method for producing calcium cyanamide was discovered in 1895 by Frank and Caro (DE 88 363 A, (1895)), who were actually looking for new methods for synthesising cyanides for gold extraction. In the Frank-Caro process, which is named after the inventors, nitrogen is conveyed over powdered calcium carbide at 1000° C., the calcium cyanamide forming in an exothermic reaction. The cyanamide can be released from aqueous suspensions of calcium cyanamide by introducing carbon dioxide.

Cyanamide is nowadays generally sold in the form of an aqueous solution, usually in a concentration range of around 50 wt.%. In addition, cyanamide is sold as a solid that has a 99% cyanamide content.

Cyanamide and its aqueous solution are versatile intermediate products, specifically for agrochemicals, active pharmaceutical ingredients, dyes and biocides (cf. Güthner, T. and Mertschenk, B. (2006) Vol. 10: Cyanamides, Ullmann's Encyclopedia of Industrial Chemistry, p. 645-667). Cyanamide itself is used inter alia as an active agricultural ingredient for dormancy breaking, as a biocide and as a pharmaceutical against alcoholism.

Therefore, DE 27 37 454 A and DE 31 50 404 C2, inter alia, describe that cyanamide can be used as an agent for influencing plant growth in viticulture, in particular for killing undesired stalks on vines, or as a bud dormancy breaking agent. In addition, EP 185 254 A1 describes that cyanamide causes the dormancy of plants or parts of plants to be prolonged. Furthermore, EP 405 510 A2 describes that cyanamide can be used for rooting cuttings. Here, cyanamide is used in each case as an aqueous solution at various concentrations. Furthermore, CN 102 599 191 A discloses that calcium cyanamide/oil suspensions can be used as a “dormancy breaking agent”.

Furthermore, it is known that aqueous cyanamide solutions are not stable over longer periods of storage, i.e. that the cyanamide in aqueous solution undergoes decomposition reactions, in particular at storage temperatures of above 20° C. Studies of this have shown that, here, urea essentially forms within a pH range of below pH 3 and above pH 12, while dimerisation to form dicyandiamide prevails from pH 8 to pH 10.0. Commercially available aqueous cyanamide solutions, which are also already mixed with stabilisers, therefore have a pH in the range of from pH 3 to 5. These commercially available aqueous cyanamide solutions can be stored at storage temperatures of between 10 and 20° C. for up to 12 months before the cyanamide content thereof noticeably decreases due to dimerisation to form dicyandiamide. In accordance with EP 95 065 B1, divalent magnesium salts are used as stabilisers in this case.

Customer surveys have now shown that storage stability in particular is being mentioned as an essential argument for the use of cyanamide as a growth regulator.

The problem addressed by the present invention is therefore to provide a composition which is used in agriculture to regulate plant growth and can be classified as safe to use. Another problem addressed by the invention is to provide a storage-stable cyanamide-containing composition having high effectiveness as a plant-growth regulator. Furthermore, a composition is intended to be provided which can be classified as harmless, and which achieves an at least identical effect in comparison with known formulations, with a lower quantity of active ingredient being used.

These problems are solved by a composition according to claim 1. Accordingly, the present invention relates to an emulsifiable or self-emulsifying liquid composition for regulating plant growth, which comprises

a) 5 to 50 wt. % cyanamide,

b) 10 to 95 wt. % of a mixture of at least one oil and at least one organic solvent that is miscible with water, and

c) 0.1 to 10 wt. % of at least one emulsifier,

wherein the cyanamide is present in the composition, in particular in the mixture and most particularly in the organic solvent, in dissolved form.

In this case, a composition according to the invention may preferably contain at least 10 wt. %, in particular at least 15 wt. % and most particularly preferably at least 20 wt. % cyanamide, while at most 50 wt. % cyanamide is contained therein.

It is essential here that the cyanamide (CH₂N₂, CAS-No. 420-04-2) is used per se and not as a salt, and that the cyanamide is present in dissolved form, in particular in the mixture in dissolved form and most particularly in the organic solvent in dissolved form. Therefore, when mixed with water, the liquid composition may form an emulsion, which can be classified as safe to use in relation to the quantity of active ingredient. If, for example, cyanamide is present in the composition in solid form, i.e. is undissolved, then an even distribution of the cyanamide would not be ensured, since an active ingredient in solid form in a liquid phase always tends towards sedimentation.

Here and within the meaning of the present invention, the term “emulsion” is understood to mean mixtures of at least two liquid components which are not completely miscible with one another and in particular have a miscibility gap. Here, one component is distributed in the form of a dispersed or internal liquid phase in another coherent external liquid phase. The term “oil-in-water emulsion”, also referred to as an O/W emulsion, within the meaning of the present invention is understood to mean an emulsion in which an oil phase is dispersed in a coherent hydrophilic, preferably aqueous, phase. The oil phase comprises a hydrophobic organic phase that is immiscible with water and comprises an oil. Here, the oil phase is dispersed in the hydrophilic, preferably aqueous, phase in the form of droplets. The term “water-in-oil emulsion”, also referred to as a W/O emulsion, within the meaning of the present invention is understood to mean an emulsion in which a water phase or an aqueous phase is dispersed in a coherent hydrophobic phase, preferably an oil phase. Within the meaning of the present invention, the term “emulsion” also covers miniemulsions and microemulsions.

Furthermore, “emulsifiable or self-emulsifying liquid composition” should also be understood to mean a liquid composition which forms an emulsion itself after being added to water (or after water being added to the composition), or which forms an emulsion after being added to water (or after water being added to the composition) and after mechanical mixing, such as stirring.

A liquid composition according to the present invention is to be understood to be a composition which has a melting point Sₘ where Sₘ<20° C. (normal pressure) and/or is liquid at a temperature of 20° C. (normal pressure) and has a viscosity of less than 1 Pa*s. The liquid compositions according to the invention preferably have a viscosity of ≦500 mPa*s, more preferably of <100 mPa*s and yet more preferably of ≦50 mPa*s at 25° C. (normal pressure). Particularly preferred are, however, those liquid compositions which have a melting point Sₘ where Sₘ<10° C. (normal pressure), most preferably a melting point Sₘ where Sₘ<0° C. (normal pressure), or are liquid at a temperature of 10° C. (normal pressure), most preferably at a temperature of 0° C. (normal pressure), and have a viscosity of less than 1 Pa*s.

It has surprisingly been found that the composition according to the invention is also storage-stable, despite it being known that cyanamide is less stable in dissolved form than in solid form. Studies of this have shown that, by using and selecting a solvent that is miscible with water, storage stability can be achieved that is longer than the storage stability of commercially available aqueous cyanamide solutions. It has also been found that by using oil, a solvent that is miscible with water and an emulsifier, a composition, in particular a concentrate, can be provided which, when water is added, can form an emulsion (i.e. a finely distributed two-phase mixture) that allows the improved application of the active ingredient. Without being bound to theory, it can be said that improved wetting of the surfaces to be treated with the active ingredient can be achieved when used as an emulsion and owing to the proportion of oil in combination with the emulsifier in the composition. As a result, the active ingredient cyanamide can be made more easily accessible for plants. At the same time, by selecting the solvent that is miscible with water, a composition can be provided which is more storage-stable in comparison with aqueous cyanamide solutions. Overall, these positive properties were not foreseeable.

In this case, in conjunction with the present invention, an organic solvent that is miscible with water is understood to mean any organic solvent that differs in definition from water, keeps cyanamide entirely in solution over a longer period of several months, and is suitable for use in agriculture. An organic solvent that is miscible with water is furthermore intended to mean that a single phase system results in a mass ratio of 1:1 with water at 20° C.

By way of these studies that form the basis of the invention, it has been found that organic solvents selected from the group of water-soluble alcohols, ketones, nitriles and amides, and mixtures thereof, can in particular be used as an organic solvent that is miscible with water.

Organic solvents selected from the group of ethanol, isopropanol, n-propanol, acetone, methyl ethyl ketone, acetonitrile, propionitrile, formamide, dimethylformamide and N-methyl pyrrilidone, and mixtures thereof, have been found to be particularly positive. According to a particularly preferred embodiment of the invention, the liquid composition contains ethanol, isopropanol and/or n-propanol as an organic solvent. Liquid compositions containing these organic solvents form particularly stable liquid formulations, which can be stored for a longer period of time compared with aqueous solutions.

As has also been shown in continuing studies, as little water as possible is intended to be contained in a composition according to the invention. Therefore, according to a development of the invention, the present invention in particular also relates to an emulsifiable or self-emulsifying liquid composition, containing less than 10 wt. %, in particular less than 5 wt. %, particularly preferably less than 3 wt. % water, more preferably less than 2 wt. % water and most preferably less than 1 wt. % water. These compositions have been found to be particularly storage-stable.

Furthermore, in conjunction with the present invention, an oil can be understood to mean any oil that is suitable for use in agriculture. In particular, the oil may be selected from the group of natural oils, in particular oils of animal or plant origin, and synthetic oils. According to the present invention, in particular natural oils, in particular plant oils, may be used as the oil. Plant oils are generally known and are commercially available. Within the meaning of the present invention, the term “plant oils” is understood to mean oils from oil-yielding plant species such as soya oil, maize germ oil, sunflower oil, rapeseed oil, cottonseed oil, linseed oil, coconut oil, palm oil, thistle oil, peanut oil, walnut oil, olive oil or castor oil, in particular rapeseed oil, plant oils also being understood to mean their transesterification products, e.g. alkyl esters such as rapeseed oil methyl ester or rapeseed oil ethyl ester.

The plant oils according to the present invention are preferably mixtures of C10 to C22 fatty acid esters. These C10 to C22 fatty acid esters are for example esters of unsaturated or saturated C10 to C22 fatty acids, in particular having an even number of carbon atoms, further preferably selected from the group of capric acid (decanoic acid), lauric acid (dodecanoic acid), myristic acid (tetradecanoic acid), palmitic acid (hexadecanoic acid), stearic acid (octadecanoic acid), arachidic acid (eicosanoic acid), palmitoleic acid (hexadec-9-enoic acid), petroselinic acid (octadec-6-enoic acid), oleic acid (octadec-9-enoic acid), elaidic acid (octadec-9-enoic acid), gadoleic acid (eicosan-9-enoic acid), erucic acid (13-docosenoic acid), linoleic acid (octadec-9,12-dienoic acid), alpha-linolenic acid (octadec-9,12,15-trienoic acid), gamma-linolenic acid (octadec-6,9,12-trienoic acid), or mixtures thereof.

Examples of plant oils are C10 to C22 fatty acid esters of glycerine or glycol having C10 to C22 fatty acids, in particular esters of the above-mentioned acids, or C10 to C22 fatty acid esters, in particular esters of the above-mentioned acids, as can be obtained for example by transesterification of said glycerine or glycol esters of the C10 to C22 fatty acids with C1 to C20 alcohols, such as methanol, ethanol, propanol or butanol.

In the liquid compositions according to the invention, the plant oils may for example be obtained in the form of commercially available plant oils, in particular rapeseed oils such as rapeseed oil methyl esters, for example Phytorob® B (Novance, France), Edenor® MESU and Agnique® ME-Series (Cognis, Germany), Radia® (ICI) or Prilube® (Petrofina).

Provided that synthetic oils are used, mineral oil, paraffin oil, white oil and synthetic fatty acid esters, in particular esters of fatty acids having an odd number of carbon atoms, such as C11 to C19 fatty acids, in particular selected from the group of undecanoic acid, tridecanoic acid, pentadecanoic acid, margaric acid (heptadecanoic acid) and nonadecanoic acid, having monovalent, divalent or trivalent C1 to C5 alcohols, in particular methanol, ethanol, propanol or butanol, are preferred.

According to the present invention, in particular an oil selected from the group of mineral oil, paraffin oil, white oil, saturated linear or branched aliphatic hydrocarbons, esters of saturated or unsaturated fatty acids having monovalent, divalent or trivalent C1 to C5 alcohols and ethers of fatty alcohols having C1 to C5 alcohols, and mixtures thereof, can therefore be used as the oil.

Furthermore, it has been found that a liquid composition having a mixture of at least one organic solvent that is miscible with water and at least one oil according to the present invention demonstrates good results in the production of the emulsion to be used if the at least one organic solvent and the at least one oil are contained in the mixture in a specified proportion relative to one another. Here, it has been found that a mixture of at least one organic solvent and at least one oil in a weight ratio of organic solvent to oil achieves particularly good results if the weight ratio corresponds to a ratio of 4:1 to 1:4, in particular of 2:1 to 1:2 and most particularly of 1.5:1 to 1:1.5. Liquid compositions having these specified weight ratios of organic solvent to oil form particularly stable emulsions.

According to a particularly preferred embodiment of the invention, the liquid composition comprises a mixture that contains ethanol as an organic solvent and a plant oil or a mixture of various esters of saturated or unsaturated fatty acids having monovalent, divalent or trivalent C1 to C5 alcohols, more preferably rapeseed oil methyl ester, as an oil, the weight ratio of ethanol to oil more preferably corresponding to the ratio of from 4:1 to 1:4, or most particularly preferably of from 2:1 to 1:2.

According to the present invention, the emulsifiable or self-emulsifying liquid composition may comprise 10 to 95 wt. % of a mixture of at least one oil and at least one organic solvent that is miscible with water. Particularly preferably, the composition may however also comprise at least 20 wt. %, in particular at least 30 wt. %, in particular at least 40 wt. %, in particular at least 50 wt. %, in particular 60 wt. % and, in combination or in isolation, at most 95 wt. % of a mixture of at least one oil and at least one organic solvent that is miscible with water. In combination or in isolation, it may however also be provided that the liquid composition comprises at most 90 wt. %, in particular at most 85 wt. %, in particular at most 80 wt. % or more preferably at most 75 wt. % of a mixture of at least one oil and at least one organic solvent that is miscible with water.

An emulsifiable or self-emulsifying liquid composition which comprises 50 to 80 wt. % of a mixture of at least one organic solvent that is miscible with water and at least one oil is particularly preferable, the weight ratio of organic solvent to oil corresponding to a ratio in the range of from 4:1 to 1:4, or most particularly preferably 2:1 to 1:2.

An emulsifiable or self-emulsifying liquid composition which comprises 50 to 80 wt. % of a mixture of ethanol and rapeseed oil methyl ester is most particularly preferable, the weight ratio of ethanol to rapeseed oil methyl ester corresponding to a ratio in the range of from 4:1 to 1:4, or most particularly preferably 2:1 to 1:2. In combination or in isolation, this composition may comprise 15 to 50 wt. % cyanamide.

So that the oil in the composition or mixture can be emulsified in the water after adding the composition to water or after adding water to the composition, or so that the water can be emulsified in the oil by itself or after mixing, a liquid composition according to the present invention comprises at least one emulsifier. It is thus also ensured that a composition that is safe to use is provided which does not form a two-phase mixture having two coherent phases immediately after the composition and the water are combined. In preferred embodiments, the liquid composition contains emulsifiers, which may be non-ionic, anionic, cationic, amphoteric or zwitterionic, or mixtures thereof. In particular, the composition comprises at least one non-ionic emulsifier.

In combination or in isolation, a composition according to the invention comprises at least one emulsifier selected from the group of oil-in-water emulsifiers (O/W emulsifier), water-in-oil emulsifiers (W/O emulsifier), oil-in-water-in-oil emulsifiers (O/W/O emulsifier) or water-in-oil-in-water emulsifiers (W/O/W emulsifier), in particular an oil-in-water emulsifier. According to a particularly preferred embodiment, the composition comprises at least one oil-in-water emulsifier and/or a non-ionic emulsifier and most particularly preferably at least one non-ionic emulsifier from the category of oil-in-water emulsifiers.

Preferred non-ionic emulsifiers are selected from the group containing fatty acid polyglycol esters, alkyl aryl polyglycol ethers, fatty alcohol polyglycol ethers, ethoxylated fatty alcohols, ethoxylated nonylphenols, fatty acid monoglycerides, fatty acid diglycerides, ethoxylated and hydrogenated or unhydrogenated castor oil and fatty acid alkanolamides.

Preferred cationic emulsifiers are selected from the group containing long-chain quaternary ammonium compounds, such as alkyltrimethylammonium salts and dialkyldimethylammonium salts having C8 to C22 alkyl groups.

Preferred anionic emulsifiers are selected from the group containing fatty alcohol sulfates, alkyl ether sulfates and alkylbenzene sulfonates.

Preferred amphoteric emulsifiers are selected from the group containing betaines, such as fatty acid amidoalkyl betaines and sulfobetaines and C8 to C22 alkyl betaines.

Non-ionic emulsifiers from the category of ethoxylated fatty alcohols are particularly preferable, in particular ethoxylated C8 to C20 alkyl alcohols. A non-ionic O/W emulsifier from the category of ethoxylated C8 to C20 alkyl alcohols is more preferable, and an iso-C13 ethoxylate is most particularly preferable.

Without being bound to theory, it can be said that improved wetting of the surfaces to be treated with the active ingredient can be achieved when using the liquid composition according to the invention, i.e. when using said composition in form of an emulsion, owing to the proportion of oil in combination with the emulsifier in the composition. Therefore, the active ingredient cyanamide can have a better effect as a plant-growth regulator compared with a purely aqueous composition.

According to the present invention, the emulsifiable or self-emulsifying liquid composition may comprise 0.1 to 10 wt. % of at least one emulsifier. Particularly preferably, the composition may however also comprise 0.1 to 5 wt. % of at least one emulsifier, and most particularly preferably 0.1 to 3 wt. % of at least one emulsifier.

Within the scope of the present invention, it may also be provided that the emulsifiable or self-emulsifying composition may comprise additional substances, in particular an additive. Here, it is also provided that the composition also comprises at least one additional additive, in particular from the group of viscosity modifiers, stabilisers, dyes and bitter principles.

Therefore, the present invention also relates to an emulsifiable or self-emulsifying liquid composition for regulating plant growth, comprising, in particular containing,

a) 5 to 50 wt. % cyanamide,

b) 10 to 95 wt. % of a mixture of at least one oil and at least one organic solvent that is miscible with water, and

c) 0.1 to 10 wt. % of at least one emulsifier, and

d) 0.1 to 5 wt. % of at least one additional additive,

the cyanamide being present in the composition, in particular in the mixture and most particularly preferably in the solvent, in dissolved form.

Most particularly preferably, an emulsifiable or self-emulsifying liquid composition for regulating plant growth according to the present invention comprises

a) 15 to 50 wt. % cyanamide,

b) 50 to 80 wt. % of a mixture of at least one oil and at least one organic solvent that is miscible with water, and

c) 0.1 to 5 wt. % of at least one emulsifier, and

d) 0.1 to 5 wt. % of at least one additional additive,

the cyanamide being present in the composition, in particular in the mixture and most particularly preferably in the solvent, in dissolved form.

It may however also be provided that a liquid composition according to the invention does not comprise any other substances in addition to the above-mentioned substances a), b), c) and optionally d), and thus consists of the above-mentioned substances. More preferably it is provided here that the liquid composition is a self-emulsifying composition and/or has a viscosity of less than 1 Pa*s.

The emulsifiable or self-emulsifying liquid composition described here has improved storage stability in comparison with an aqueous, already stabilised cyanamide solution, and is ideally suited for regulating plant growth and as a formulation for a cyanamide-containing plant-growth regulator. Therefore, within the scope of the present invention, said invention also relates to an emulsion which is produced from or together with said emulsifiable or self-emulsifying liquid composition and comprises or contains water and said liquid composition.

Here, the ready-to-use emulsion preferably comprises water and the liquid composition according to the invention in a weight ratio of from 1000:1 to 1:1, preferably 500:1 to 2:1, in particular 200:1 to 10:1 and most preferably 150:1 to 20:1.

Furthermore, the present invention also relates to the use of the emulsifiable or self-emulsifying liquid composition or of an emulsion which is produced from or together with said emulsifiable or self-emulsifying liquid composition as an agent for regulating plant growth, in particular as a plant-growth regulator.

The following examples are intended to explain the invention in greater detail.

### EXAMPLES

### Example 1

### Production of the Formulation According to the Invention

352 g of refined rapeseed oil methyl ester was placed in a stirred tank. 376 g of ethanol (waterless, denatured with approx. 1% petroleum ether) and 25 g Marlosol TA3050 (an iso-C13 ethoxylate, manufactured by Sasol AG, Marl) were introduced. Then 247 g of solid cyanamide (cyanamide F1000, manufactured by AlzChem AG) was added to the mixture and stirred for 1 hour with gentle heating at 20° C. This resulted in 1000 g of a clear, yellowish solution. A formulation of this type is usually referred to as an emulsion concentrate (EC).

Marlosol TA3040 can be replaced with the technically equivalent products Lutensol TO5 (manufactured by BASF) or TEGO Alkanol TD6 (manufactured by Evonik-Goldschmidt) with an identical result.

### Example 2

### Testing of the Stability of the Formulation According to the Invention

100 g of the formulation from example 1 was placed into a PE flask and stored at 60° C. in a heating cabinet. The concentration of cyanamide and the concentration of the resulting dimer dicyandiamide were tracked analytically. A commercially available nominally 50% aqueous cyanamide formulation (Dormex, manufactured by Alzchem AG) and an aqueous cyanamide solution (produced by mixing 50 g of Dormex and 50 g of demineralised water) diluted to 25% were used as a comparison. The results of the stability test were as follows:

| | Formulation from | | |
|---|---|---|---|
| | example 1 | 50% Dormex | Dormex diluted to 25% |
| Initial values | 25.8% cyanamide | 51.1% cyanamide | 25.9% cyanamide |
| at the start of | 0.05% dicyandiamide | 0.8% dicyandiamide | 0.49% dicyandiamide |
| heated storage | | | |
| After 48 hours | 25.1% cyanamide | 49.8% cyanamide | 25.1% cyanamide |
| at 60° C. | 0.42% dicyandiamide | 2.1% dicyandiamide | 0.99% dicyandiamide |
| | corresponds to a relative | corresponds to a relative | corresponds to a relative |
| | loss of active ingredient | loss of active ingredient | loss of active ingredient |
| | of 2.7% | of 2.5% | of 3.1% |
| After 96 hours | 23.8% cyanamide | 46.0% cyanamide | 22.7% cyanamide |
| at 60° C. | 1.45% dicyandiamide | 6.0% dicyandiamide | 3.51% dicyandiamide |
| | corresponds to a relative | corresponds to a relative | corresponds to a relative |
| | loss of active ingredient | loss of active ingredient | loss of active ingredient |
| | of 7.8% | of 10.0% | of 12.3% |

From experience, this accelerated storage test at 60° C. simulates the typical storage stability at room temperature over a time period of 1 to 2 years. The results show that the relative loss of active ingredient (the decrease in cyanamide based on the starting cyanamide concentration) in the EC formulation according to the invention is improved compared with the established Dormex solution, particularly for longer storage times. As the comparative tests using the 25% aqueous solution show, this effect is not attributable to the lower cyanamide concentration, but to the non-aqueous formulation that can thus be stored in an improved manner.

### Example 3a

### Production of an Application Solution

98 g tap water was placed in a stirred tank, and 2.0 g of the solution according to the invention from example 1 (of the EC concentrate) was added thereto. Within a few seconds, an evenly cloudy oil-in-water emulsion formed, the cyanamide proportion mainly transitioning into the water phase.

### Example 3b

### Production of a Comparative Application Solution

For comparison, a purely aqueous solution (corresponding to the prior art) of 1.0 g Dormex (having a content of 51.1% cyanamide) in 99.0 g of tap water was produced.

The two application solutions 3a and 3b had a concentration of active ingredient of around 0.5% cyanamide.

### Example 4

### Testing as a Growth Regulator for Plants

At the start of the dormancy period at the end of November, cuttings were taken from an apple tree of the Topaz variety and were each cut to 15 cm in length (approx. 6 bud eyes). The cuttings were divided into 3 groups.

Group 1 was immersed in pure tap water for 15 seconds and then left to drip.

Group 2 was immersed in the application solution according to the invention from example 3a for 15 seconds and also left to drip.

Group 3 was immersed in the comparative application solution from example 3b and left to drip.

The cutting from groups 1, 2 and 3 were each separately placed into glass containers filled with tap water and were incubated for 30 days at 20° C. with artificial lighting. The results showed the following:

Group 1: no budding was observed.

Group 2: much budding was observed; in most cases 3 to 4 buds formed short shoots having 3 to 4 leaves.

Group 3: moderate budding was observed, preferably at the shoot tips, usually having just 2 to 3 leaves.

In summary, it was that found that the formulation according to the invention has an advantageous effect on budding, and has an effect that is improved in comparison with the known aqueous Dormex formulation.

In summary, the EC formulation according to the invention allows improved storage stability of the active ingredient concentrate solution in combination with an improved dormancy breaking effect of the application solution.

1.-12. (canceled)

13. An emulsifiable or self-emulsifying liquid composition for regulating plant growth, comprising:
a) 5 to 50 wt. % cyanamide;
b) 10 to 95 wt. % of a mixture of at least one oil and at least one organic solvent that is miscible with water; and,
c) 0.1 to 10 wt. % of at least one emulsifier, wherein the cyanamide is present in the composition in dissolved form.

14. The composition of claim 13, wherein the organic solvent is selected from the group consisting of water-soluble alcohols, ketones, nitriles and amides, and mixtures thereof.

15. The composition of claim 13, wherein the organic solvent is selected from the group consisting of ethanol, isopropanol, n-propanol, acetone, methyl ethyl ketone, acetonitrile, propionitrile, formamide, dimethylformamide and N-methyl pyrrilidone, and mixtures thereof.

16. The composition of claim 13, wherein the composition contains less than 5 wt. % water.

17. The composition of claim 13, wherein the composition contains less than 3 wt. % water.

18. The composition of claim 13, wherein the oil is selected from the group consisting of mineral oil, paraffin oil, white oil, saturated linear or branched aliphatic hydrocarbons, esters of saturated or unsaturated fatty acids having monovalent, divalent or trivalent C1 to C5 alcohols and ethers of fatty alcohols having C1 to C5 alcohols, and mixtures thereof

19. The composition of claim 13, wherein the mixture contains the organic solvent and the oil in a ratio range of organic solvent to oil of from 4:1 to 1:4.

20. The composition of claim 13, wherein the mixture contains the organic solvent and the oil in a ratio range of organic solvent to oil of from 2:1 to 1:2.

21. The composition of claim 13, wherein the emulsifier is an ionic, a non-ionic or a zwitterionic emulsifier.

22. The composition of claim 13, wherein the emulsifier is selected from the group consisting of oil-in-water emulsifiers (O/W emulsifier), water-in-oil emulsifiers (W/O emulsifier), oil-in-water-in-oil emulsifiers (O/W/O emulsifier) and water-in-oil-in-water emulsifiers (W/O/W emulsifier).

23. The composition of claim 13, further comprising at least one additional additive.

24. The composition of claim 23 wherein the additional additive is selected from the group consisting of viscosity modifiers, stabilisers, dyes and bitter principles.

25. The composition of claim 13, wherein the composition is a self-emulsifying composition.

26. The composition of claim 13, wherein the composition has a viscosity of less than 1 Pa*s.

27. The composition of claim 25, wherein the composition has a viscosity of less than 1 Pa*s.

28. An emulsion for regulating plant growth comprising water and the composition of claim 13.
